(19) United States
(12) Patent Application Publication
(10) Pub. No.: US 2009/0185125 A1
(43) Pub. Date: Jul. 23, 2009

(54) LIQUID CRYSTAL DISPLAY DEVICE

(76) Inventors: Yoshito HIDA, Kobe-shi (JP); Naofumi SATO, Ibo-gun (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/350,347

(22) Filed: Jan. 8, 2009

(30) Foreign Application Priority Data
Jan. 22, 2008 (JP) 2008-011857

(51) Int. Cl. G02F 1/1343

(52) U.S. Cl. 349/141

(57) ABSTRACT

A liquid crystal display device includes a first substrate, a second substrate which is disposed to be opposed to the first substrate, and a liquid crystal layer which is held between the first substrate and the second substrate. The first substrate includes a first electrode and a second electrode which is disposed to be opposed to the first electrode via an insulating layer. The first electrode includes pixel electrode portions and first slits which are provided between the pixel electrode portions and define the pixel electrode portions, and the second electrode includes counter-electrode portions which are disposed to be opposed to the first slits, and second slits which are provided to be opposed to the pixel electrode portions.

### CROSS-REFERENCE TO RELATED APPLICATIONS

This application is based upon and claims the benefit of priority from prior Japanese Patent Application No. 2008-011857, filed Jan. 22, 2008, the entire contents of which are incorporated herein by reference.

### BACKGROUND OF THE INVENTION

1. Field of the Invention

The present invention relates generally to a liquid crystal display device, and more particularly to an active matrix liquid crystal display device.

2. Description of the Related Art

In general, a liquid crystal display device includes a liquid crystal display panel which comprises an array substrate, a counter-substrate which is disposed to be opposed to the array substrate, and a liquid crystal layer which is held between the array substrate and the counter-substrate.

In recent years, there has been a demand for a higher fineness, a smaller size and a wider viewing angle of the liquid crystal display device. As methods for realizing wider viewing angles, there have been proposed an IPS (In-Plane Switching) mode liquid crystal display apparatus and an FFS (Fringe-Field Switching) mode liquid crystal display apparatus wherein an electric field in an in-plane direction of a glass substrate, that is, a transverse electric field, is generated, and liquid crystal molecules are rotated by this the transverse electric field in a plane parallel to the substrate, thereby varying the transmittance of light.

In the FFS mode liquid crystal display device, a pixel electrode is disposed on a counter-electrode via an insulation layer, and a slit is provided in the pixel electrode. By making use of the slit, an electric field is generated in a direction from the pixel electrode towards a common electrode. This electric field has, as well as a transverse electric field component, an electric field component in a direction perpendicular to the substrate in the vicinity of the edge of the electrode. Liquid crystal molecules, which are positioned above the electrode, can also be driven by this electric field component in the direction perpendicular to the substrate.

In the above-described FFS mode liquid crystal display device, an insulation layer is disposed between the pixel electrode and the counter-electrode, and an electric field that is used for driving the liquid crystal is generated by a voltage that is applied to the pixel electrode and the counter-electrode. At this time, a capacitance component occurs in the insulation layer, which is disposed between the pixel electrode and the counter-electrode, by the voltage that is applied to the pixel electrode and the counter-electrode. In the case where the capacitance component occurs in the insulation layer in this manner, polarization occurs, in particular, in the vicinity of the electrode, and an image persistence phenomenon occurs in some cases.

In order to suppress the occurrence of the image persistence phenomenon, there has been proposed a liquid crystal display device wherein an opening portion is formed in the insulation layer that is disposed between the pixel electrode and the counter-electrode, thereby decreasing the capacitance component occurring in the insulation layer due to the voltage that is applied between the pixel electrode and the counter-electrode (see Jpn. Pat. Appln. KOKAI Publication No. 2007-183299).

However, in the case of providing the opening portion in the insulation layer as described above, it becomes difficult, in some cases, to set the pixel electrode and the counter-electrode in the insulation state, with the progress in the fineness of display and the size of the liquid crystal display device, leading to a decrease in manufacturing yield.

### BRIEF SUMMARY OF THE INVENTION

The present invention has been made in consideration of the above-described problem, and the object of the invention is to provide a liquid crystal display device with a good display quality, which can suppress an image persistence phenomenon, without decreasing a manufacturing yield.

According to an aspect of the present invention, there is provided a liquid crystal display device comprising a first substrate, a second substrate which is disposed to be opposed to the first substrate, and a liquid crystal layer which is held between the first substrate and the second substrate, wherein the first substrate includes a first electrode and a second electrode which is disposed to be opposed to the first electrode via an insulating layer, the first electrode includes pixel electrode portions and first slits which are provided between the pixel electrode portions and define the pixel electrode portions, and the second electrode includes counter-electrode portions which are disposed to be opposed to the first slits, and second slits which are provided to be opposed to the pixel electrode portions.

The present invention can provide a liquid crystal display device with a good display quality, which can suppress an image persistence phenomenon, without decreasing a manufacturing yield.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for describing an example of the structure of a liquid crystal display device according to an embodiment of the present invention;

FIG. 2 is a view for describing an example of the structure of a display pixel of the liquid crystal display device shown in FIG. 1;

FIG. 3 schematically shows an example of the cross section of an array substrate, which is taken along line III-III in FIG. 2;

FIG. 4 is a graph for explaining an example of an evaluation result of the liquid crystal display device according to the embodiment of the invention and a liquid crystal display device according to a comparative example; and

FIG. 5 schematically shows an example of the cross section of an array substrate of the liquid crystal display device according to the comparative example.

### DETAILED DESCRIPTION OF THE INVENTION

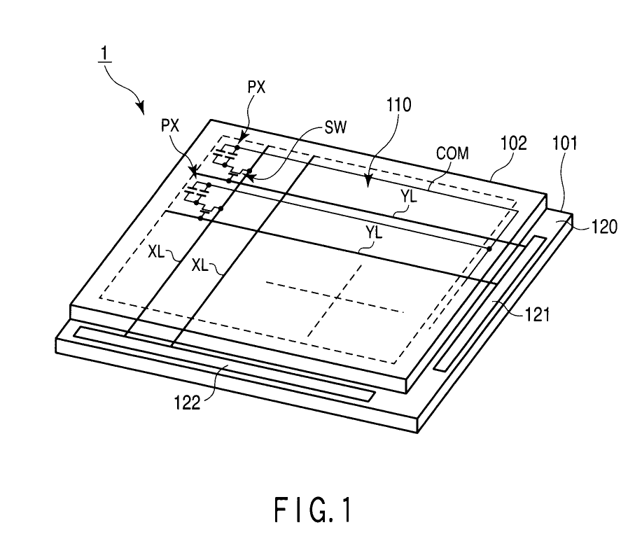

A liquid crystal display device according to an embodiment of the present invention will now be described with reference to the accompanying drawings. As shown in FIG. 1, the liquid crystal display device according to the embodiment includes a liquid crystal display panel 1 which includes a pair of mutually opposed substrates, namely, an array substrate 101 and a counter-substrate 102, and a liquid crystal layer (not shown) which is held between the paired substrates 101 and 102.

As shown in FIG. 1, the liquid crystal display panel 1 includes a display section 110 which is composed of a plurality of display pixels PX arranged in a matrix. In the display section 110 of the array substrate 101, disposed are scanning lines YL (YL1 to YLm) extending along rows in which the plural display pixels PX are arranged, signal lines XL (XL1 to XLn) extending along columns in which the plural display pixels PX are arranged, and a counter-voltage supply line COM.

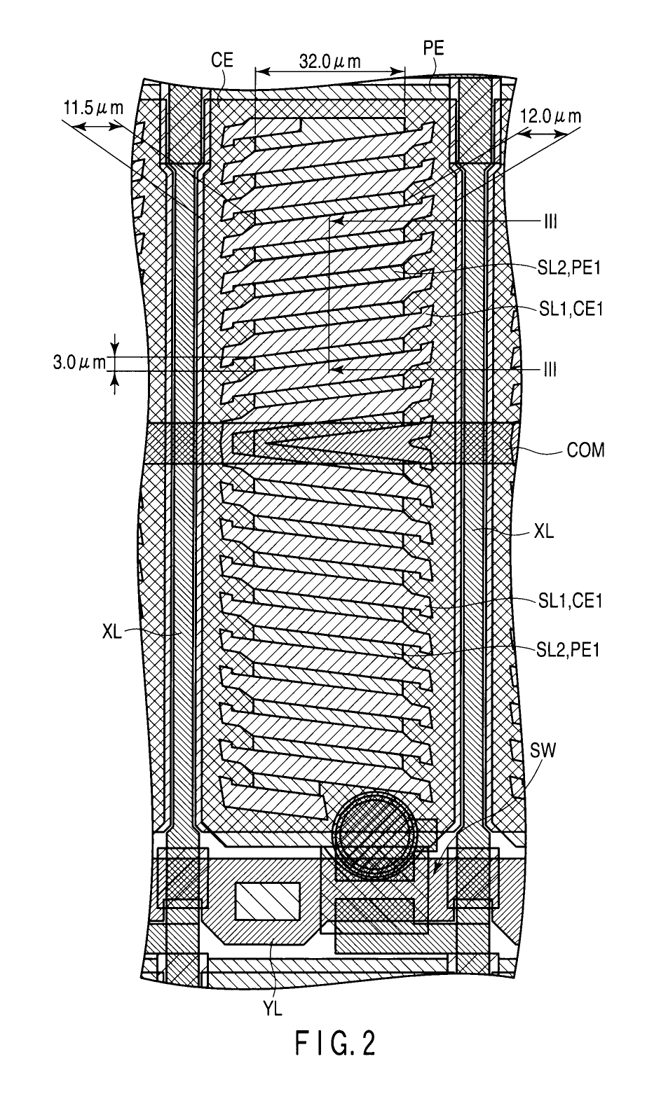

Each of the plural display pixels PX includes a pixel switch SW which is disposed near an intersection between the scanning line YL and signal line XL on the array substrate 101. The pixel switch SW includes, for instance, a thin-film transistor (TFT) as a switching element. The gate terminal of the pixel switch SW is electrically connected to the associated scanning line YL. The source terminal of the pixel switch SW is electrically connected to the associated signal line XL. The drain terminal of the pixel switch SW is connected to a pixel electrode PE (shown in FIG. 2) which is disposed in each of the display pixels PX.

On peripheral areas of the display section 110, disposed are a scanning line driving circuit 121 to which the scanning lines YL are connected, a signal line driving circuit 122 to which the signal lines XL are connected, and a counter-voltage supply circuit (not shown). The scanning line driving circuit 121 successively drives the scanning lines YL, thereby rendering conductive the source-drain path of the pixel switch SW which is provided in each of the display pixels PX. The signal line driving circuit 122 successively drives the signal lines XL, thereby applying a source voltage to the pixel electrode PE of the associated display pixel PX via the pixel switch SW. The counter-voltage supply circuit supplies a counter-voltage to the counter-electrode CE via the counter-voltage supply line COM.

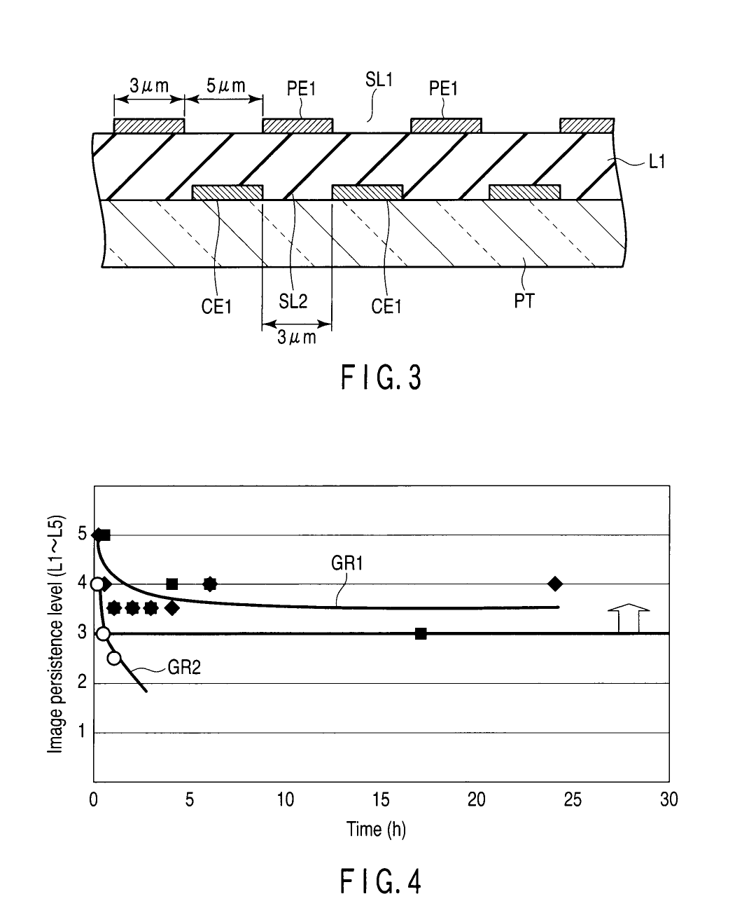

As shown in FIG. 2 and FIG. 3, in the liquid crystal display device according to the present embodiment, the array substrate 101 includes the counter-electrode CE which is disposed on an insulative transparent substrate PT, and the pixel electrode PE which is disposed above the counter-electrode CE via an insulating layer L1. The pixel electrode PE and the counter-electrode CE are disposed to be opposed to each other via the insulating layer L1. The pixel electrode PE has a substantially rectangular shape, and is disposed in each of the display pixels PX. The pixel electrode PE and the counter-electrode CE are formed of, e.g. ITO (Indium Tin Oxide).

The pixel electrode PE, as shown in FIG. 2 and FIG. 3, includes pixel electrode portions PE1, and first slits SL1 which are provided between neighboring pixel electrode portions PE1. As shown in FIG. 3, in the liquid crystal display device according to the present embodiment, the width of the pixel electrode PE1 of the pixel electrode PE is about 3 μm, and the width of the first slit SL1 is about 5 μm.

The counter-electrode CE includes counter-electrode portions CE1, which are so disposed as to be opposed to the first slits SL1 via the insulating layer L1, and second slits SL1 which are so disposed as to be opposed to at least parts of the pixel electrode portions PE1 via the insulating layer L1.

In the liquid crystal display device according to the present embodiment, the width of the second slit SL2 is substantially equal to that of the pixel electrode portion PE of the pixel electrode PE, and is about 3 μm. Specifically, the second slits SL2 of the counter-electrode CE are disposed below the pixel electrode portion PE1, and no capacitance component occurs in the insulating layer L1 under the pixel electrode portions PE1 of the pixel electrode PE.

In addition, in the liquid crystal display device according to this embodiment, the area of the second slits SL2 of the counter-electrode CE is set to be about 36% of the area (hereinafter referred to as “capacitance area”) of the counter-electrode CE in the state prior to the formation of the second slits SL2.

It should suffice if the second slits SL2 are disposed in a manner to decrease the capacitance component that occurs in the insulating layer L1 due to the voltage that is applied to the pixel electrode PE and the counter-electrode CE, and it should suffice if the second slits SL2 are so provided as to be opposed to at least parts of the electrode portions of the pixel electrode PE. Accordingly, there is no need to make the width of the second slit SL2 equal to the width of the pixel electrode PE.

For example, in the liquid crystal display device according to the present embodiment, the area of the second slits SL2 is about 36% of the area of the counter-electrode CE in the state prior to the formation of the second slits SL2. However, the ratio of the area is not limited to this value.

A source voltage corresponding to each display pixel PX is applied to the electrode portion of the pixel electrode PE via the signal line XL. A counter-voltage is applied to the counter-electrode CE via the counter-voltage supply line COM. Thus, an electric field is generated at the electrode portions of the pixel electrode and the neighborhood of the counter-electrode due to voltages which are applied by the source voltage and the counter-voltage. This electric field includes an electric field component in a direction substantially parallel to the substrate surface of the array substrate 101 and an electric field component in a direction substantially perpendicular to the substrate surface of the array substrate 101. Liquid crystal molecules included in the liquid crystal layer are driven by this electric field.

A color display type liquid crystal display device includes a plurality of kinds of display pixels PX, for instance, a red pixel which displays red, a green pixel which displays green, and a blue pixel which displays blue. For example, the red pixel includes a red color filter (not shown) which passes light with a principal wavelength of red. The green pixel includes a green color filter (not shown) which passes light with a principal wavelength of green. The blue pixel includes a blue color filter (not shown) which passes light with a principal wavelength of blue. These color filters are disposed, for example, on the counter-substrate 102.

The array substrate 101 and counter-substrate 102 are fixed so as to be opposed to each other by a sealant (not shown) which is disposed in a manner to surround the periphery of the display section 110.

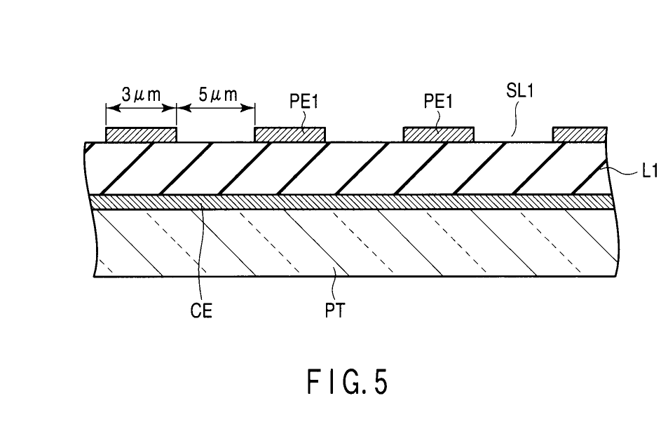

FIG. 4 shows an example of the evaluation results relating to the liquid crystal display device according to the present embodiment and a liquid crystal display device in which second slits SL2 are not provided in the counter-electrode CE as shown in FIG. 5 (hereinafter referred to as “liquid crystal display device according to a comparative example”). In FIG. 4, the abscissa indicates time (h), and the ordinate indicates an image persistence level (L1 to L5). FIG. 4 shows the relationship between the elapsed time and the image persistence level in the case where the evaluation of image persistence was conducted with respect to the liquid crystal display device according to the present embodiment and the liquid crystal display device according to the comparative example, as will be described below.

In this evaluation, two liquid crystal display devices according the present embodiment and one liquid crystal display device according to the comparative example were prepared, and these devices were evaluated. In FIG. 4, a graph GR1 indicates a mean value of the image persistence level of the liquid crystal display devices according to the embodiment, and a graph GR2 indicates the image persistence level of the liquid crystal display device according to the comparative example.

Two liquid crystal display devices according to the present embodiment and one liquid crystal display device according to the comparative example were prepared, and these liquid crystal display devices were caused to display image persistence patterns. In this evaluation, for example, a black-and-white checkered pattern of a six-pixel unit was displayed as the image persistence pattern. The example of the image persistence pattern is not limited to this checkered pattern. Proper display patterns may be adopted in evaluating the presence/absence of the image persistence phenomenon. The image persistence pattern was caused to be displayed, and the image persistence level was evaluated at predetermined time intervals in five levels (L1 to L5).

As regards the image persistence levels, level L5 is a level at which no image persistence is visually recognized at all. Level L4 is a level at which a slight image persistence is visually recognized when the viewing angle is increased, but no image persistence is visually recognized in the frontal direction. Level L3 is a level at which an image persistence is visually recognized, when viewed through a filter which lowers luminance. Level L2 is a level at which an image persistence is clearly visually recognized. Level 1 is a level at which an image persistence is visually recognized even in a black display state.

In this evaluation, when it is determined whether the image persistence level is level L3 or not, the evaluation was conducted by using, for example, a filter which sets the luminance of the liquid crystal display panel 1 at 10%.

As a result of the above-described evaluation, as shown in FIG. 4, the image persistence level of the liquid crystal display device according to the comparative example decreased to level L3 or below within two hours from the beginning of the evaluation. By contrast, in the liquid crystal display device according to the present embodiment, the display quality of level L3 or more was successfully maintained even after 25 hours from the beginning of the evaluation.

The reason for this appears to be that in the liquid crystal display device according to the comparative example the counter-electrode CE is disposed under the pixel electrode PE, and so a capacitance component occurred in the insulating layer L1 that is disposed between the pixel electrode PE and the counter-electrode CE, leading to polarization in the vicinity of edges of the electrode portions of the pixel electrode PE and easy occurrence of image persistence.

On the other hand, in the liquid crystal display device according to the present embodiment, the second slit SL2 of the counter-electrode CE is disposed under the electrode portions of the pixel electrode PE. It appears, therefore, that the capacitance component occurring in the insulating layer L1 that is disposed between the pixel electrode PE and the counter-electrode CE was successfully decreased, thereby suppressing polarization in the vicinity of edges of the electrode portions of the pixel electrode PE and suppressing occurrence of image persistence.

Furthermore, in the liquid crystal display device according to the present embodiment, since the insulating layer L1 is uniformly disposed between the pixel electrode PE and the counter-electrode CE, the manufacturing yield does not lower due to electrical conduction between the pixel electrode PE and the counter-electrode CE.

In the meantime, in the manufacturing process of the liquid crystal display device according to the present embodiment, the second slits SL2 of the counter-electrode CE can be formed at the same time in the conventional fabrication step of the counter-electrode by using a mask which is so formed as to remove the electrode material of the parts of the second slits SL2. Thus, the number of fabrication steps of the liquid crystal display device does not increase due to the provision of the second slits SL2 in the counter-electrode CE as described above.

In short, the present embodiment can provide a liquid crystal display device with a good display quality, which can suppress an image persistence phenomenon, without decreasing a manufacturing yield.

The present invention is not limited directly to the above-described embodiment. In practice, the structural elements can be modified and embodied without departing from the spirit of the invention.

In addition, various inventions can be made by properly combining the structural elements disclosed in the embodiment. For example, some structural elements may be omitted from all the structural elements disclosed in the embodiment. Furthermore, structural elements in different embodiments may properly be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A liquid crystal display device comprising a first substrate, a second substrate which is disposed to be opposed to the first substrate, and a liquid crystal layer which is held between the first substrate and the second substrate,
wherein the first substrate includes a first electrode and a second electrode which is disposed to be opposed to the first electrode via an insulating layer,
the first electrode includes pixel electrode portions and first slits which are provided between the pixel electrode portions and define the pixel electrode portions, and
the second electrode includes counter-electrode portions which are disposed to be opposed to the first slits, and second slits which are provided to be opposed to the pixel electrode portions.

2. The liquid crystal display device according to claim 1, wherein a width of the pixel electrode portion is substantially equal to a width of the second slit.
